(19) United States
(12) Patent Application Publication
(10) Pub. No.: US 2022/0242615 A1
(43) Pub. Date: Aug. 4, 2022

(54) SYSTEM FOR CONTAINER CONTENT IDENTIFICATION

(71) Applicant: Grove Collaborative, Inc., San Francisco, CA (US)

(72) Inventors: Nichole GUY, San Francisco, CA (US); Chu-Min LEE, San Francisco, CA (US); Luana Louzada BUMACHAR, Tenafly, NJ (US)

(21) Appl. No.: 17/167,013

(22) Filed: Feb. 3, 2021

(51) Int. Cl. B65D 23/08; G09F 3/02; G09F 23/00

(52) U.S. Cl. CPC B65D 23/0885; G09F 3/02; G09F 2023/0025; G09F 2003/0273; G09F 23/00

(57) ABSTRACT

Apparatus, methods, devices for container content identification is described herein. In some variations, an apparatus may include a container comprising a plurality of labels. The apparatus may also include a cover at least partially surrounding the container. The cover may include a labeling region selectively positionable to expose a label of the plurality of labels. The exposed label may be indicative of a container content type.

### TECHNICAL FIELD

This invention relates generally to the field of containers, such as for container content identification.

### BACKGROUND

One cost-effective and environment-friendly approach of storing different types of content is to re-use and/or re-purpose a container. For instance, containers may be used for a first content type at a first point in time and may be then re-purposed and used for another content type at a different point in time. However, this may make it challenging for a user to remember what type of content may be in the container at a specific time.

In order to identify different contents in a container, traditional methods employ methods such as using label stickers, laminated tags and/or the like. However, these methods often prove ineffective. For example, a user may be deterred from storing a content type in the container that does not correspond to the label on the container. If the user does proceed with storing a content type that does not correspond to the label, then this may lead to confusion. Additionally, if the container is labeled with labels that include adhesives, there may be a likelihood that the adhesives are weak, consequently making the labels fall off.

Therefore, there is an unmet need to provide new and improved methods of enabling identification of content in a container.

### SUMMARY

Methods, devices, and systems that enable identification of content in a container are described herein. In some variations, an apparatus comprises a container comprising a plurality of labels. A cover may at least partially surround the container. The cover may include a labeling region selectively positionable to expose a label of the plurality of labels. The exposed label may be indicative of a container content type.

In some variations, the cover comprises a sleeve. In some variations, the cover comprises silicone. The labeling region may not include the silicone. In some variations, the labeling region may be a negative space. In some variations, the negative space may comprise a transparent material. In some variations, the negative space may include a color filter. In some variations, the labeling region may have a first color that is different from a second color of the cover.

In some variations, a segment of the cover surrounding a bottom portion of the container may include a cutout. The cover may be configured to be detachable from the container. The cover surrounding the container may be rotatable relative to the container such that the labeling region may be selectively positioned to expose a second label of the plurality of labels. In some variations, the content may be of a first type and the second label may be indicative of a second container content type.

In some variations, the labeling region may be rotatable around a longitudinal axis of the container. The plurality of labels may be oriented parallel to the longitudinal axis of the container. In some variations, the plurality of labels may be oriented at an angle relative to the longitudinal axis of the container.

In some variations, the labeling region may be translatable along a longitudinal axis. The plurality of labels may be oriented perpendicular to the longitudinal axis. In some variations, the plurality of labels may be oriented at an angle relative to the longitudinal axis.

In some variations, one or more labels of the plurality of labels may be indicative of a type of cleaner solution. The plurality of labels may be on a surface of the container. In some variations, the apparatus may further comprise a dispenser coupled to the container. A first color of the dispenser may match a second color of the cover.

In some variations, a method comprises placing a cover on a container such that the cover at least partially surrounds the container. The cover may comprise a plurality of labels. The method may also include positioning the cover to selectively position a labeling region in the cover to expose a label of the plurality of labels. The label may be indicative of a container content type.

In some variations, positioning the cover may comprise rotating the cover around a longitudinal axis of the container. The plurality of labels may be oriented parallel to the longitudinal axis of the container. In some variations, the plurality of labels may be oriented at an angle relative to the longitudinal axis of the container.

In some variations, positioning the cover may comprise sliding the cover along a longitudinal axis of the container. The labeling region may be oriented perpendicular to the longitudinal axis of the container. In some variations, the labeling region may be oriented at an angle relative to the longitudinal axis of the container.

In some variations, the method may further comprise manipulating the cover to selectively position the labeling region to expose a second label of the plurality of labels. The second label may be indicative of a second container content type. In some variations, the cover may comprise a sleeve. In some variations, the cover may comprise silicone. The labeling region may not include the silicone.

In some variations, the labeling region may be a negative space. The negative space may comprise a transparent material. In some variations, the negative space may include a color filter. In some variations, the method may further comprise detaching the cover from the container. In some variations, one or more labels in the plurality of labels may be indicative of a type of cleaner solution. The plurality of labels may be on a surface of the container.

In some variations, the method may further comprise coupling a dispenser to the container. The method may further comprise selecting the dispenser such that a first color of the dispenser may match a second color of the cover.

### BRIEF DESCRIPTION OF THE DRAWINGS

FIG. 1 illustrates an exemplary variation of a system for container content identification.

FIG. 2 illustrates an exemplary variation of a container including a plurality of labels each indicating a respective content type.

FIG. 3A illustrates an exemplary variation of a container including a plurality of labels each indicating a respective content type.

FIG. 3B illustrates an exemplary variation of a container including a plurality of labels indicating a respective content type.

FIG. 4 illustrates an exemplary variation of a cover enabling container content identification.

FIG. 5A illustrates an exemplary variation of a cover including a labeling region perpendicular to a longitudinal axis of the cover.

FIG. 5B illustrates an exemplary variation of a cover including a labeling region angled relative to a longitudinal axis of the cover.

FIG. 5C illustrates an exemplary variation of a cover including a labeling region angled relative to a longitudinal axis of the cover.

FIG. 6 illustrates a top view of an exemplary variation of a cover enabling container content identification.

FIG. 7 illustrates an exemplary variation of an exploded view of a system for container content identification.

FIG. 8A illustrates an exemplary variation of a system in which the cover is positioned to expose a first label on the container.

FIG. 8B illustrates an exemplary variation of a system in which the cover is positioned to expose a second label on the container.

FIG. 8C illustrates an exemplary variation of a system in which the cover is positioned to expose a third label on the container.

FIG. 8D illustrates an exemplary variation of a system in which the cover is positioned to expose a fourth label on the container.

FIGS. 9-11 illustrates exemplary variations of a system for container content identification, in which a cover includes a plurality of labels indicating a respective content type and a container includes a label indicator.

FIGS. 12 and 13 illustrates exemplary variations of a system for container content identification, in which a cover includes or functions as a label indicator and a container includes a plurality of labels.

### DETAILED DESCRIPTION

Non-limiting examples of various aspects and variations of the invention are described herein and illustrated in the accompanying drawings.

Some containers may be re-purposed to store different types of content. For instance, a container may be re-purposed to store different types of cleaning solutions (e.g., cleaning solutions for shower, tub and tile, glass, etc.). In a similar manner, a mason jar may be re-purposed to store different types of spreads (e.g., jams, jellies, marmalades, etc.). However, labeling such containers to indicate the type of content in the container may be challenging.

Traditional methods of labeling contents in a container include using tags, label stickers, etc. However, this can be an ineffective way of labeling contents. For instance, if the container is already labeled with a first label, a user may be deterred to place content types that do not correspond to the first label into the container. Moreover, if the user does proceed with placing a second content type in the container, the labeling (e.g., first label that does not correspond to the second content type) on the container may cause confusion.

In some instances, when a first content type in the container is switched for a second content type, the container may need to be re-labelled to indicate the second content type. However, traditional methods can make this a cumbersome process. For example, switching a first label (e.g., a first label sticker) for a second label (e.g., a second label sticker) may require removing the first label from the container. If adhesives are used to attach the labels to the container, removing the first label may leave behind a residue (e.g., portions of the first label, portions of the adhesive, etc.). Such residue may be relentless and may end up damaging the container. Furthermore, if the second label is attached to the container in the exact same place as the first label, the residue from the first label may interfere with the second label making it difficult to read the second label. Additionally, the residue from the labels may make recycling the container challenging. Therefore, traditional methods of labeling contents in a container may prove to be ineffective.

Methods, devices, and system disclosed herein enable content identification for a container in a simple and easy-to-use manner. In addition to enabling content identification, the technology described herein may protect the container and provide heat insulation and/or better grip.

### Exemplary System

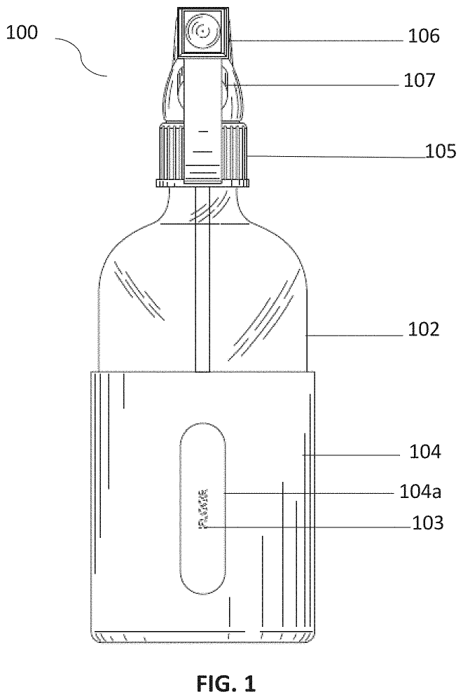

FIG. 1 illustrates an exemplary variation of a system 100 for container content identification. The system 100 may include a container 102. At least a portion of the container 102 may include one or more labels such as label 103. For example, the container 102 may include a plurality of labels 103, where each label (e.g., label 103) may represent or otherwise indicate a respective content type. A cover 104 may at least partially surround the container 102. The cover 104 may include a labeling region 104a that may be selectively positionable to expose a label (e.g., label 103 on the container 102).

### Container

The container 102 may be any suitable container for storing one or more contents. In some variations, the container 102 may include any suitable shape with a substantially curved portion. For example, the container 102 may include a substantially cylindrical portion. Alternatively, the container 102 may include a rectangular shaped portion. For example, a bottom portion of the container 102 may be substantially square shaped, substantially rectangular shaped, etc. The container may have a radially-symmetrical cross-section or other symmetrical cross-section (e.g., bi-lateral symmetry, tri-lateral symmetry, quadrilateral symmetry, other symmetry along any suitable number of axes such as 5, 6, 7, 8 or more, etc.). Furthermore, in some variations the container 102 may have a varied cross-sectional shape. For example, the container 102 may have a cross-sectional shape that varies along a longitudinal axis of the container (e.g., tapered profile, such as a cone or pyramid, or a portion thereof such as frustoconical). In some variations, the container 102 may be rigid. Alternatively, the container 102 may be semi-rigid. For instance, the container 102 may be a flexible container configured to be compressed and/or stretched and/or the container 102 may be a squeezable container. The container 102 may comprise any suitable material such as glass, metal, plastic, and/or the like.

The container 102 may include a cap 105 or any other closure device to close the container 102. The cap 105 may be attached to the container 102 in any suitable manner. For example, the cap 105 may be attached to the container 102 using threads, snap-fit assembly, one or more hinges, a combination thereof, and/or the like. In some variations, the cap 105 may be or include a dispenser. The dispenser may in some instances include a nozzle (e.g., nozzle 106 in FIG. 1) and a handle (e.g., trigger 107 in FIG. 1) to actuate the nozzle. In other variations, the cap 105 may include a pump dispenser with a dispensing tip (e.g., needle tip). In some variations, the dispenser may include a dispenser cover that is at least partially removed or disengaged to access the dispenser (e.g., threaded, snap fit, hinged).

In some variations, the cap 105, nozzle 106, and trigger 107 may comprise a same material (e.g., plastic, metal). Alternatively, the material of the cap 105, nozzle 106, and/or trigger 107 may be different from the other. In some variations, the nozzle 106 may be color-coded to indicate a type of content in the container 102. For example, the nozzle 106 may include a first color to indicate a first content. When the container 102 is re-purposed to store a second content, the nozzle 106 may be switched to another nozzle having a second color indicating the second content. In a similar manner, additionally or alternatively, the trigger 107 may be color-coded to indicate a type of content in the container 102. In some variations, the entire cap 105 (as opposed to portions of the cap 105 such as nozzle 106 and/or trigger 107) may be color-coded to indicate a type of content in the container 102. In some variations, the color of the nozzle 106 may match that of the cover 104. In such variations, the nozzle 106 and the cover 104 may be collectively color-coded to indicate a type of content in the container. In a similar manner, the color of the trigger 107 may match that of the cover 104. Additionally or alternatively, the color of the cap 105 may match that of the cover 104.

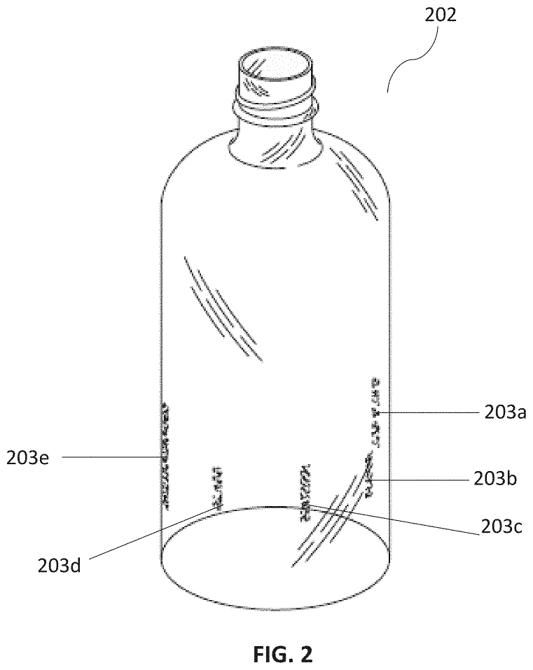

The container 102 may include a plurality of labels (e.g., label 103) that represent a content type. FIG. 2 illustrates an exemplary variation of a container 202 (e.g., similar to container 102 in FIG. 1) including a plurality of labels 203a-203e representing a respective content type. The labels 203a-203e, collectively referred to as labels 203, may be any suitable character and/or a combination of suitable characters representing a respective content type. For example, each label 203 may be a text including one or more alphabets, numbers, symbols, special characters, emoticons, a combination thereof, and/or the like indicating a content type. Additionally or alternatively, each label 203 may be a graphic symbol (e.g., an icon) representing a content type.

The labels 203 may be disposed on, attached to, and/or integrated with the container 202. In some variations, the labels 203 may be etched on an outer surface and/or an inner surface of the container 202. For instance, the labels 203 may be engraved/inscribed (e.g., text and/or graphic symbol representing the content type may be engraved) on a surface of the container 202. A protective layer may be disposed on the engraving to protect the labels from damage. Additionally or alternatively, the labels 203 may be printed on an outer surface and/or an inner surface of the container 202. For instance, the text and/or the graphic symbol representing the content type may be painted on a surface of the container 202. In yet other variations, the labels 203 may be embedded within the walls of the container. For example, the labels 203 may be integrated within the container 202 during the fabrication of the container 202. In still other variations, the labels 203 may be decals that are integrated during the fabrication of the container 202. Alternatively, the labels 203 may be decals that are attached to an outer surface and/or an inner surface of the container 202 after the fabrication of the container 202. In still other variations, a portion of the container 202 may be configured to include custom labels. For example, a portion of the outer surface of the container 202 may include a blank space. A user may place a custom label in the blank space based on the content type included in the container 202 (e.g., by writing directly in the blank space on the container, attaching a separate label to the blank space on the container, etc.).

As shown in FIG. 2, the labels 203 may be disposed on, attached to, and/or integrated with the container 202 parallel to a longitudinal axis. In some variations, each label 203 may be at equal distance from each other. Alternatively, at least some labels may be at a different distance from their adjacent labels compared to other labels on the container 202. In some variations, the labels 203 may be disposed along the entire circumference of the container 202. Alternatively, all of the labels 203 may be disposed along a portion of the circumference of the container 202. For example, one half of the circumference of the container 202 may include the labels 203 while the other half of the circumference of the container 202 may not include any label 203.

A cover (e.g., cover 104 in FIG. 1) partially covering the container 202 may include a labeling region (e.g., labeling region 104a in FIG. 1) to expose one or more labels on the container 202. In some variations, each label 203 may be at a same height on the container 202. For example, each label 203 may begin at a same height from the topmost edge of the container 202. In such variations, the labeling region (e.g., labeling region 104a in FIG. 1) on a cover (e.g., cover 104 in FIG. 1) may be oriented along the longitudinal axis. The cover may be rotated around the longitudinal axis to expose different labels 203 on the container 202 through the labeling region. For example, the cover may be rotated around the longitudinal axis to expose a selected label having a certain circumferential position on the container. Alternatively, the labels 203 may be parallel to the longitudinal axis but at different heights on the container 202. In such variations, the cover may be configured to be slidable (or extendable) and/or rotatable along the longitudinal axis in order to expose a selected label having a certain longitudinal and/or circumferential position on the container. The combination of sliding and/or rotating the cover may expose the different labels 203 on the container 202. Furthermore, in some variations the cover may include two parts disposed, including one on top of the other. An inner part may be configured to be slidable along the longitudinal axis. An outer part disposed on top of the inner part may be configured to be rotatable along the longitudinal axis. The outer part may include the labeling region. The combination of sliding the inner part and rotating the outer part of the cover may expose different labels 203 at different longitudinal positions and circumferential positions on the container 203. Additional features of the cover are described in further detail below.

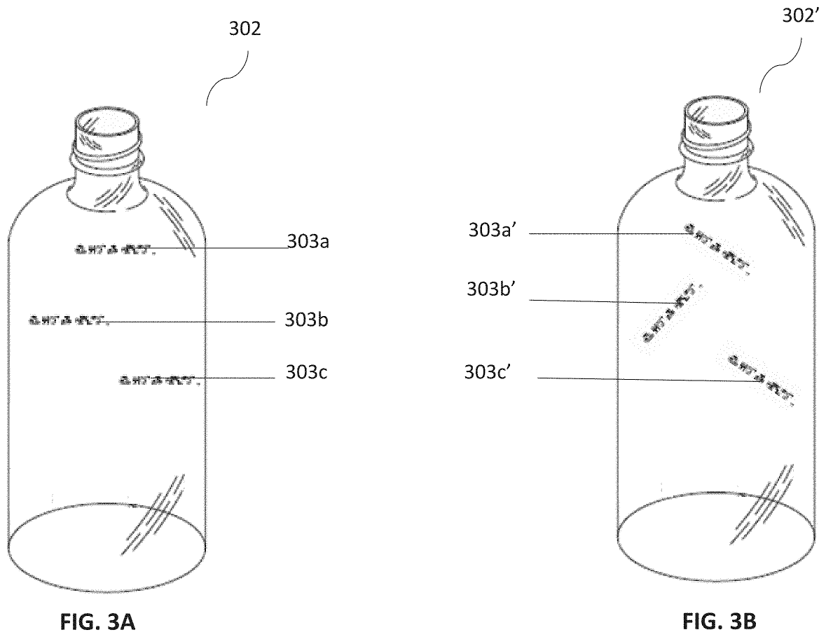

Although FIG. 2 shows the labels 203 as parallel to the longitudinal axis, the labels 203 may have any suitable orientation relative to the longitudinal axis. For example, FIGS. 3A-3B show containers 302 and 302′ including labels having various orientations relative to the longitudinal axis. In FIG. 3A, the labels 303a-303c may be disposed perpendicular to a longitudinal axis. The labels 303 may be at equal distance or at different distance from their adjacent labels. The labels 303 may all be disposed on a portion of a circumference of the container 302 or along the entire circumference of the container 302. In some variations, each label 303 may be at a same height on the container 302. In such variations, the labeling region (e.g., labeling region 104a in FIG. 1) on a cover (e.g., cover 104 in FIG. 1) may be oriented perpendicular to the longitudinal axis, and may be rotated around the longitudinal axis to expose different labels 303 on the container 302. Alternatively, as shown in FIG. 3A, the labels 303 may be perpendicular to the longitudinal axis and at different heights on the container 302. In such variations, the cover may be configured to be both slidable and rotatable along the longitudinal axis. The combination of sliding and rotating the cover may expose the different labels 303 on the container 302.

As shown in FIG. 3B, the labels 303a′-303c′ may be disposed at various angles relative to the longitudinal axis. For example, in FIG. 3B, labels 303a′ and 303c′ may be disposed at 135 degrees relative to the longitudinal axis while label 303b′ may be disposed at 45 degrees relative to the longitudinal axis. In such variations, a cover (e.g., cover 104 in FIG. 1) may, for example, include two segments. A first segment may include a first labeling region (e.g., labeling region 104a in FIG. 1) oriented at an angle of 135 degrees relative to the longitudinal axis. A second segment may include a second labeling region (e.g., labeling region 104a in FIG. 1) oriented at an angle of 45 degrees relative to the longitudinal axis. The first segment may be rotated along the longitudinal axis to expose labels 303a′ and 303c′ through the first labeling region while the second segment may be rotated along the longitudinal axis to expose label 603b through the second labeling region. If the labels 303′ are at different heights on the container 302′, a combination of sliding and rotating the first segment and/or the second segment may expose the different labels 303′ on the container 302′. It should be understood that in other variations, the labels on a container may have any suitable orientation relative to the longitudinal axis of the container.

### Cover

Cover 104 may surround at least a portion of the container 102 and include at least one labeling region that matches or corresponds to the orientation of at least one label on the container. For example, if the labels are oriented parallel to the longitudinal axis, the labeling region (e.g., labeling region 104 in FIG. 1) may also be oriented parallel to the longitudinal axis. Alternatively, if the labels are oriented perpendicular to the longitudinal axis, the labeling region may also be oriented perpendicular to the longitudinal axis. In yet other variations, if the labels are oriented at a specific angle relative to the longitudinal axis, the labeling region may be oriented at that angle relative to the longitudinal axis.

The cover 104 may have any suitable shape for surrounding at least a portion of the container 102. For example, the cover 104 may include a cross-sectional shape that may surround at least a portion of the circumference and/or perimeter (e.g., one-tenth, one-eighth, one-sixth, one-fourth, half, three-fourths, and/or the like) of an outer surface of the container 102. In some variations, the cover 104 may include a cross-sectional shape that may surround the entire circumference and/or perimeter of an outer surface of the container 102. The cross-section of the cover may be at least a portion of any suitable shape such as circular, elliptical, polygonal (e.g., triangular, rectangular, etc.), and/or the like. Similar to the container 102 described above, in some variations, the cover 104 may have a radially-symmetrical cross-section or other suitable symmetrical cross-section (e.g., bilateral symmetry, tri-lateral symmetry, quadrilateral symmetry, other symmetry along any suitable number of axes such as 5, 6, 7, 8 or more, etc.). Furthermore, the cover 104 may have a cross-section that varies along a longitudinal axis (e.g., tapered, such as cone-shaped or pyramidal-shaped, or portion thereof such as frustoconical shape). In some variations, the cover 104 may at least partially surround a bottom portion of the container 104 (e.g., the cover 104 may be a sleeve with one open end and one closed bottom end). Alternatively, the cover 104 may not surround the bottom portion of the container 104 (e.g., the cover 104 may be a sleeve having two open ends).

In some variations, the height of the cover 104 may be lower than the height of the container 102. For example, the height of the cover 104 may be any suitable fraction of the height of the container 102 (e.g., one-eighth the height of the container 102, one-sixth the height of the container 102, one-fourth the height of the container 102, half the height of the container 102, etc.). The thickness of the cover 104 may be any suitable thickness. For instance, the thickness of the cover 104 may depend on the thickness of the container 102. Additionally or alternatively, the thickness of the cover 104 may depend on factors such as anticipated use of the container 102, anticipated terrain in which the container 102 may be used, the type of contents to be stored in the container 102, a combination thereof, and/or the like. For example, if the anticipated use of the container is rough usage, such as using the container 102 during intense outdoor activities and/or in rough terrains, the thickness of the cover 104 may be relatively high. In contrast, if the anticipated use of the container 102 is for solely for storing contents such as for storing cleaning solutions, the thickness of the cover 104 may be relatively low. In a similar manner, if the anticipated use of the container 102 is to store extremely hot or extremely cold content, the thickness of the cover 104 may be relatively high to allow for good thermal insulation.

Cover 104 may help protect the container 102 from damage. For instance, the cover 104 may protect the container 102 from breakage (e.g., when the container falls from a height). Additionally or alternatively, cover 104 may protect at least a portion of the container 102 from environmental pollutants (e.g., dust, soot, allergens, etc.). In some variations, cover 104 may provide heat insulation. For instance, cover 104 may insulate a user's hand from the temperature of the content (e.g., hot content or cold content) in the container 102. In some variations, cover 104 may enable a user to firmly grip the outer surface of the container 102. For example, the cover 104 may include a frictional material, textural features (e.g., bumps, ridges, recesses, finger grips, etc.).

Cover 104 may comprise any suitable material. For example, cover 104 may comprise synthetic rubbers such as neoprene, polymers such as silicone, synthetic polymers such as nylon, cotton, a combination thereof, and/or the like. In some variations, cover 104 may include a relatively high frictional material (e.g., silicone) to improve engagement with the container 102 and/or facilitate grip or handling of the container. In some variations, cover 104 may be a silicone sleeve that may at least partially surround the container 102. The inner diameter of the cover 104 may be sized based on the diameter of the container 102. For example, the inner diameter of the cover 104 may be sized so as to fit the outer surface of the container 102 in a snug manner. Additionally or alternatively, the inner diameter of the cover 104 may be sized so as to fit some but not all portions of the outer surface of the container 102 in a snug manner. For instance, the inner diameter of the cover 104 may be sized to fit the broadest portion of the container 102. In such variations, the fit of the cover 104 around a relatively narrow portion of the container 102 may be substantially loose.

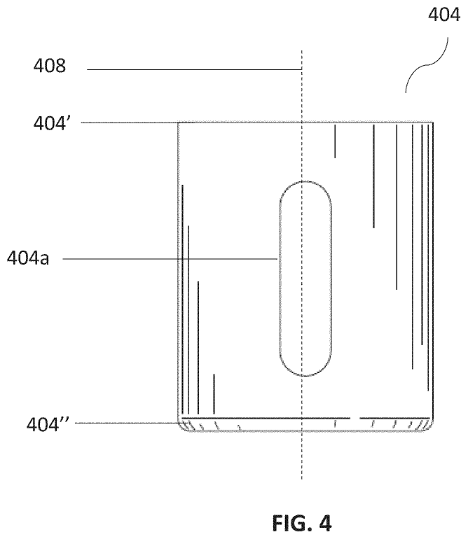

FIG. 4 illustrates an exemplary variation of a cover 404 (e.g., similar to cover 104 in FIG. 1) enabling container content identification. The cover 404 includes a top portion 404′. In some variations, the cover 404 may also include a bottom portion 404″. The cover 404 may be attached to an outer surface of a container (e.g., container 102 in FIG. 1). The cover 404 may be attached by inserting the container from the top portion 404′ of the cover 404. In some variations, the cover 404 may be inserted such that a bottom portion of the container may touch and/or contact a bottom portion 404″ of the cover 404. Alternatively, the container may be inserted from the top portion 404′ of the cover 404 such that the bottom portion of the container extends out of the bottom portion 404″ of the cover 404. In some variations, the bottom portion 404″ of the cover 404′ may include a cutout/hole as further described below. In some variations, the cutout/hole may enable attaching and/or detaching the cover 404 from the container more easily as described below.

The cover 404 also includes a labeling region 404a that may be selectively positionable to expose a label. For example, the labeling region 404a may function as a window through which the exposed label may be visible.

In some variations, the labeling region 404a may be a negative space on the cover 404. For example, the cover 404 may be designed so as to include the negative space (e.g., an empty space, empty arc, etc.), thereby forming the labeling region 404a. The negative space may be integrated with the cover 404 during fabrication of the cover 404. Alternatively, the negative space may be created on the cover 404 by carving/cutting/slitting a portion of the cover 404 after the cover 404 has been fabricated.

In some variations, the labeling region 404a may be a gap on the cover 404 that at least partially surrounds the container 102. For instance, a cover having a C-shaped cross-section may be designed to include a longitudinal gap that functions as the labeling region 404a. The gap may be included in the cover 404 during the fabrication of the cover 404 (e.g., by injection molding, by molding a sheet of material into a curve, etc.). Alternatively, the gap may be created on the cover 404 after the cover has been fabricated (e.g., by cutting away a longitudinal strip of material to form a longitudinal gap in the cover).

In some variations, the labeling region 404a may comprise a transparent material. For example, cover 404 may be fabricated such that a portion of the cover 404 may be formed using a transparent material (e.g. transparent plastic film, clear glass, epoxy resin, etc.) while the rest of the cover 404 may be fabricated from one or more suitable materials such as neoprene, silicone, nylon, cotton, and/or the like. In some variations, the labeling region 404a comprising the transparent material may be integrated with the cover 404 during the fabrication of the cover 404 (e.g., by using an appropriate mold). Alternatively, after the cover 404 has been fabricated, at least one portion of the cover 404 may be carved, cut, and/or slit out. Transparent material may then be disposed, attached, and/or affixed on the carved/cut/slit portion of the cover 404.

In some variations, the labeling region 404a may include one or more polarizing filters to manage polarized light reflected from/absorbed on the surface of the container (e.g., container 102 in FIG. 1). The polarizing filters may be mounted on, disposed on, attached to, and/or affixed to the cover 404 after the cover 404 has been fabricated. Alternatively, the polarizing filters may be integrated with the cover 404 during the fabrication of the cover 404. In some variations, the labeling region 404a may include one or more color filters. The color filters may be mounted on, disposed on, attached to, and/or affixed to the cover 404 after the cover has been fabricated. Alternatively, the color filters may be integrated with the cover 404 during the fabrication of the cover 404. In some variations, the labeling region 404a may have a different color than that of the cover 404.

Although FIG. 4 depicts the labeling region 404a as having an elongated region with curved or rounded (semi-circular) ends, it should be readily understood that the labeling region 404a can have any suitable shape. For example, the labeling region 404a may be wavy, and/or at least a portion of the labeling region 404a may be triangular shaped, circular shaped, diamond shaped, pyramid shaped, etc. Furthermore, although FIG. 4 illustrates a single labeling region 404a on the cover 404, it should be readily understood that in other variations, two or more labeling regions may be included on the cover 404.

The labeling region 404a may have any suitable orientation relative to the longitudinal axis 408. For example, the labeling region 404a may be along the longitudinal axis 408 as seen in FIG. 4. In such a variation, a container (e.g., container 102 in FIG. 1) may include labels along and/or parallel to the longitudinal axis 408 (e.g., such as labels 203 in FIG. 2). The labeling region 404a may be selectively positionable so as to expose a label. For example, the cover 404 may be rotated along the longitudinal axis 408 until a label of choice is exposed via the labeling region 404a. As an example, referring back to FIG. 1, the container 102 may include the label 103. Label 103 may be oriented along and/or parallel to a longitudinal axis (not shown in FIG. 1). In order to expose the label 103, the cover 104 may be rotated (e.g., along the longitudinal axis) such that the labeling region 104a exposes the label 103. As described above, the labeling region 104a may be a negative space that exposes the label 103 on the container 102. Alternatively, the labeling region 104a may comprise one or more transparent materials that exposes the label 103 on the container 102. In this example, similar to FIG. 4, the labeling region 104a in FIG. 1 may be oriented along a longitudinal axis.

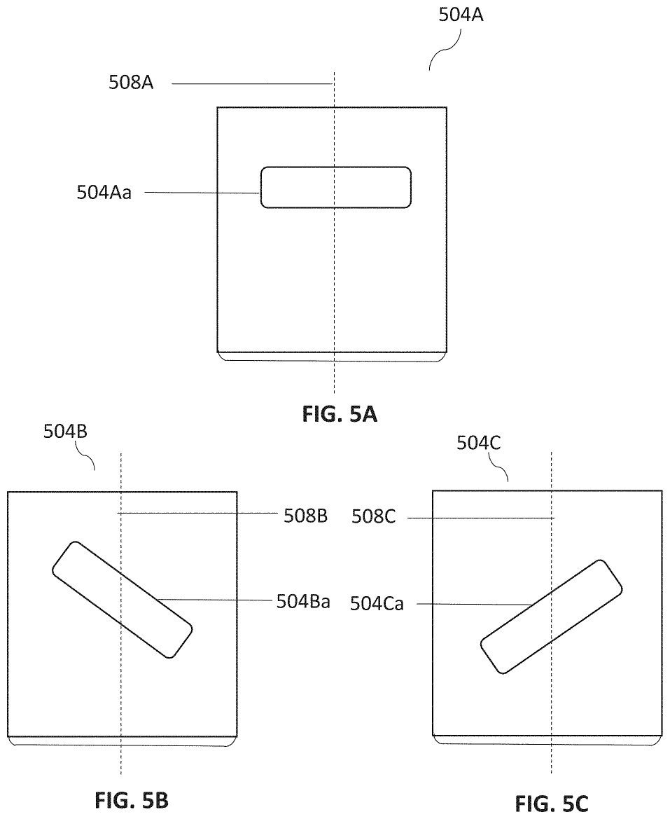

As mentioned above, the labeling region 404a may have any suitable orientation relative to the longitudinal axis (e.g., 20 degrees, 30 degrees, 45 degrees, 60 degrees, 75 degrees, 105 degrees, 135 degrees, etc.). FIGS. 5A-5C illustrate exemplary variations of covers 504A, 504B, and 504C with labeling regions having different orientations relative to the longitudinal axis of the cover. In FIG. 5A, the labeling region 504Aa is perpendicular to the longitudinal axis 508A. In such a variation, a container (e.g., container 102 in FIG. 1) may include labels perpendicular to the longitudinal axis 508A. In variations in which all of the labels are perpendicular to the longitudinal axis 508A and at the same height or longitudinal position along the longitudinal axis 508A, the cover 504A may be rotatable around the longitudinal axis to selectively expose the labels. In variations in which at least some of the labels are at different heights or longitudinal positions, the cover 504A may further be slidable along the longitudinal axis 508A so as to expose the labels on the container. For example, cover 504A may be slidable to move up and/or down along the longitudinal axis 508A. The up and/or down movement of the cover 504A may result in an up and/or down movement of the labeling region 504Aa along the longitudinal axis 508A. Accordingly, as the cover 504A slides along the longitudinal axis, the labeling region 504Aa may expose one or more labels that may be oriented perpendicular to the longitudinal axis 508A on the container. In some variations, a combination of rotating and sliding the cover 504A relative to the longitudinal axis 508A may expose the labels on the container (for e.g., in the variation shown in FIG. 3A, a combination of sliding and rotating a cover such as cover 504A may expose the labels 303a-303c on the container 302).

In FIGS. 5B and 5C, the labeling region 504Ba and 504Ca may be oriented at an angle (e.g., 135 degrees and 45 degrees) relative to the longitudinal axis 508B and 508C. In such variations, a container (e.g., container 102 in FIG. 1) may include labels having a similar orientation (e.g., 135 degrees and 45 degrees) relative to the longitudinal axis 508B and 508C. At least some of the angled labels may also be at different heights or longitudinal positions along the longitudinal axis 508B and 508C. Accordingly, the cover 504B/504C may be rotatable and/or slidable such that the movement of the cover 504B/504C may expose one or more labels on the container through the labeling region 504Ba/504Ca. For example, the cover 504B/504C may be rotated along the longitudinal axis 508B/508C. Additionally or alternatively, the cover 504B/504C may be slidable relative to the longitudinal axis 508B/508C. The movement of the cover 508B/508C (i.e., rotational and/or sliding) may result in the movement of the labeling region 504Ba/504Ca. The movement of the labeling region 504Ba/504Ca may expose the labels on the container.

Although the labeling region in FIGS. 5A-5C are described as being selectively positioned owing to the rotational and/or slidable movement of the cover, it should be readily understood that the labeling region may additionally or alternatively be selectively positioned by other suitable methods as well. For example, in some variations, the cover may be vertically collapsible. For example, referring back to FIG. 1, the cover 104 may in some variations include horizontal pleats that may be compressed and/or expanded, and the labeling region may be moved up and/or down by compressing and/or expanding the horizontal pleats. Accordingly, the compression and/or expansion of the pleats may move the labeling region 104a, thereby exposing one or more labels (e.g., a label oriented parallel to a longitudinal axis). In a similar manner, the cover 104 may in some variations be horizontally (e.g., circumferentially) collapsible. In this variation, the cover 104 may include vertical pleats that may be compressed and/or expanded. The labeling region 104a may be moved sideways (e.g., perpendicular to a longitudinal axis) by compressing and/or expanding the vertical pleats. Accordingly, the movement of the pleats may move the labeling region 104a horizontally, thereby exposing one or more labels (e.g., a label oriented perpendicular to a longitudinal axis). Additionally or alternatively, the cover may include a stretchable material, such that the cover may be reshaped through pushing, pulling, twisting, and/or other suitable manipulation so as to longitudinally and/or rotationally reposition the labeling region 104a, and/or reshape the contours of the labeling region 104a itself in relation to a desired label location and/or shape.

Although the cover 104 has been described as moving (e.g., rotating, sliding, compressing, expanding, etc.) as a whole, it should be readily understood that only a portion of the cover 104 may be moved to selectively position the labeling region 104a. For example, the cover 104 may include an inner frame with a top and a bottom edge. The top and/or the bottom edge of the inner frame may be configured to slide along the container 102 (e.g., slide along a longitudinal axis). A rotating cylinder including the labeling region 104a may be integrated with, attached to, disposed on, coupled to, and/or affixed to the inner frame. The rotating cylinder may be configured to rotate along the longitudinal axis. In such variations, although the inner frame may be stationary, the rotating cylinder may rotate along the longitudinal axis, thereby selectively positioning the labeling region 104a. Additionally or alternatively, a combination of the rotation of the rotating cylinder and an upward and/or a downward movement of the top and/or bottom edge of the inner frame may selectively position the labeling region 104a to expose a label such as label 103. In some variations, the inner frame and the rotating cylinder may comprise different materials. For example, the inner frame of the cover 104 may comprise a rigid material (e.g., plastic, metal, etc.) while the rotating cylinder of the cover 104 may comprise silicone. Alternatively, the inner frame and the rotating cylinder may comprise the same material (e.g., silicone).

In some variations, the labeling region 104a may expose a single label (e.g., label 103) on the container 102 while the remaining portion of the cover 104 may cover the rest of the labels on the container 102. Alternatively, the labeling region 104a may highlight or otherwise emphasize a single label (e.g., via polarizing filters, color filters, etc.) while at least some of the rest of the labels (non-highlighted labels) may still be exposed on the container but not emphasized in the same manner as the highlighted label. In some variations, multiple labels located at multiple positions on the container 102 may represent the same container content type, and the cover 104 may include more than one labeling region 104a to expose these multiple labels simultaneously. For example, a first label indicating a container content type may be on a right side of the container 102, and a second label indicating the same container content type may be on a left side of the container 102 (e.g., container content type printed twice on the container 102). In this example, the cover may include a first labeling region and a second labeling region, where the container content type may be visible through both the first labeling region positionable on the right side of the container, and through the second labeling region positionable on the left side of the container. However, a container content type may be repeated any suitable number of times, and the cover may include any suitable corresponding number of labeling regions.

In some variations, if the cover 104 does not include a relatively high frictional material (e.g., silicone) to improve engagement with the container 102, other suitable methods may be used to engage the cover 104 with the container 102. For instance, a combination of at least a portion of the cover 104 and at least a portion of the container 102 may together include a latch mechanism. For example, an outer surface of the container 102 may include one or more recesses and/or dents. An inner surface of the cover 104 may include one or more bumps and/or protrusions. When the cover 104 is rotated, the bumps and/or protrusions on the inner surface of the cover 104 may engage with the recesses and/or dents on the container 102 (e.g., detents). The engagement of the protrusions with the dents may latch the cover 104 to the container 102. Additionally or alternatively, an outer surface of the container 102 may include one or more bumps and/or protrusions. The inner surface of the cover 104 may include one or more recesses and/or dents. The engagement of the protrusions on the container 102 with the dents on the cover 104 may latch the cover 104 to the container.

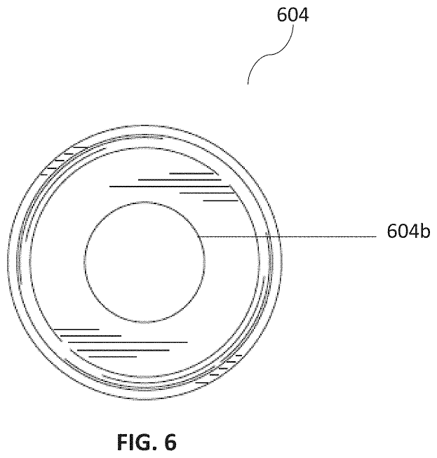

FIG. 6 illustrates a top view of an exemplary variation of a bottom portion of a cover 604 (e.g., similar to cover 104 in FIG. 1, cover 404 in FIG. 4, and covers 504A-504C in FIGS. 5A-5C) enabling container content identification. The cover 604 may include a cutout/hole 604b. The cutout 604b may enable attachment and/or detachment of the cover 604 from a container (e.g., container 102 in FIG. 1) with ease. For example, cutout 604b may relieve pressure formed in the bottom portion of the cover, when a container is being inserted into a cavity of the bottom portion of the cover, thereby facilitating placement of the cover onto the container. Furthermore, when the cover 604 is attached to the container such that the cover 604 holds a bottom portion of the container in a snug manner, detaching the cover 604 from the container may be challenging. Due to the snugness, it may be difficult to grip the cover 604 in order to detach it. Additionally, applying excess force to detach the cover 604 by pulling the edges of the cover 604 may damage the cover 604. The cutout 604b may help overcome this challenge. By placing a hand through the cutout 604b, an inner surface of the cover 604 may be held. For example, the inner surface of the bottom portion of the cover 604 may be held by inserting a finger through the cutout 604b such that the finger touches a portion of the inner surface. The thumb may be placed on an outer surface of the bottom portion of the cover 604 such that at least a region of the bottom portion of the cover 604 is in between the thumb and the finger that touches the inner surface. The cutout 604b enables better grip of the bottom portion of the cover 604. The cover 604 may then be detached from the container by applying a force (e.g., by pulling the inner surface) on the inner surface of the cover 604. By pulling away the inner surface of the cover 604 from the container through the cutout 604b, the cover 604 may be detached from the container with ease.

Although the cover 604 shown in FIG. 6 has a single cutout 604b that is circular, it should be understood that in some variations the cover may have any suitable number and/or shape of cutouts. For example, the cutout 604b may be elliptical, substantially linear or wavy (e.g., a slit), triangular, etc. A single cutout 604b may be centered in the bottom portion of the cover, or the cutout may be off-center. Furthermore, the cover may two, three, four, five, or six of more cutouts arranged in any suitable pattern (e.g., radially symmetric, radially asymmetric, random, regular or irregular array, etc.). Furthermore, as described above, in some variations the cover may omit a bottom portion.

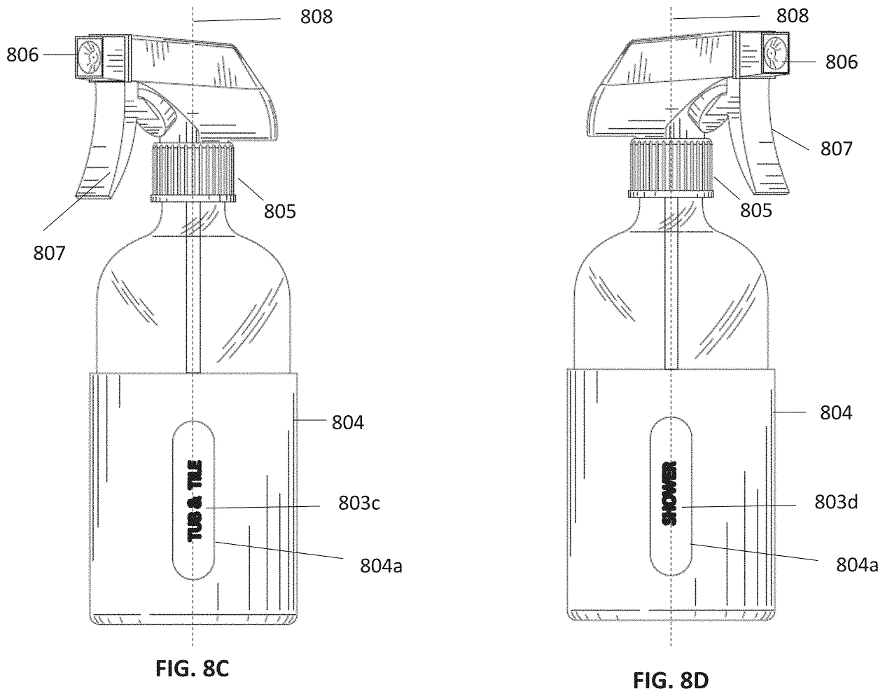

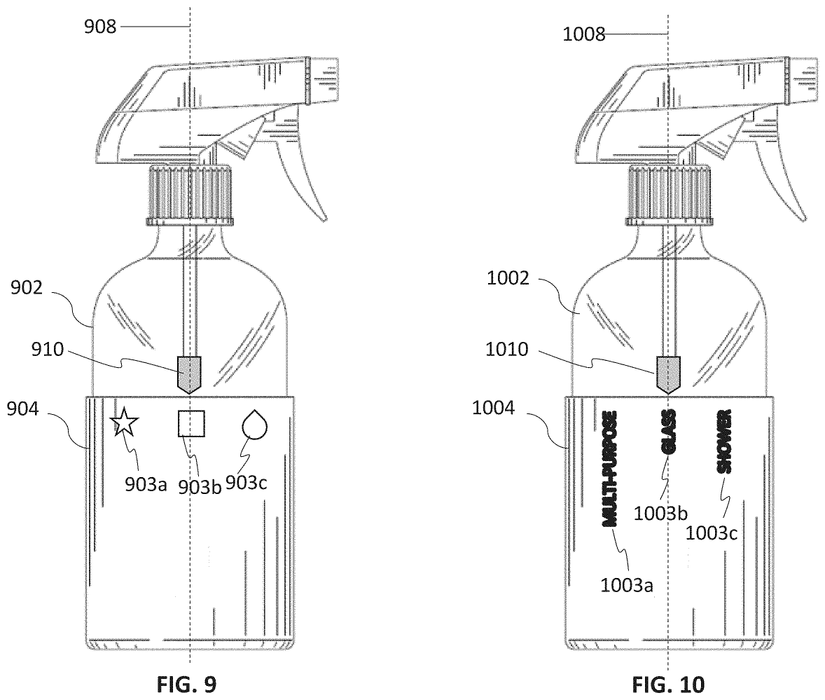

In some variations, the plurality of labels that indicate container content type may additionally or alternatively be arranged on the cover, and container content type may be indicated by manipulating (e.g., repositioning, reshaping, etc.) the cover relative to a label indicator on the container. For example, as shown in FIG. 9, in some variations a cover 904 may include a plurality of labels 903a-903c, where each label is indicative of a container content type. At least a portion of the labels may include a cutout (similar to the labeling regions described above), where different labels may be represented by different cutout shapes (e.g., star, square, teardrop, etc.). Additionally or alternatively, at least a portion of the labels may include an icon that is printed, etched, molded, or otherwise applied to or formed into the cover material. Furthermore, in some variation, as shown in FIG. 10, at least a portion of the labels (e.g., 1003a-1003c) may include text that communicates container content types, such as full description (e.g., “multi-purpose”, “glass”, “shower”, etc.) or abbreviations (e.g., “MP”, “GL”, “SH”).

The cover 904 may be placed on a container 902 that includes a label indicator 910. The label indicator 910 may be formed on or in the container 902 in any suitable manner, such as that described above with respect to plurality of labels on or in the container (e.g., etching, printed, applied as a decal, formed within the container wall or on the container surface, etc.). Although the label indicator 910 shown in in FIG. 9 is in the shape of an arrow, it should be understood that the label indicator 910 may have any suitable shape (e.g., line, circle, dot, star, other graphical design, etc.). Furthermore, in some variations, the label indicator 910 may additionally or alternatively include a textural feature such as one or more outward projections or inward projections (e.g., bump, recess, ridge, channel, etc.). The cover 904 may be manipulated (e.g., rotated around longitudinal axis 908) to align a desired label (e.g., 903a, 903b, 903c) with the label indicator 910. The cover 1004 shown in FIG. 10 and with like numbering as cover 904 shown in FIG. 9, may be operated in a similar manner as that described above with respect to cover 904.

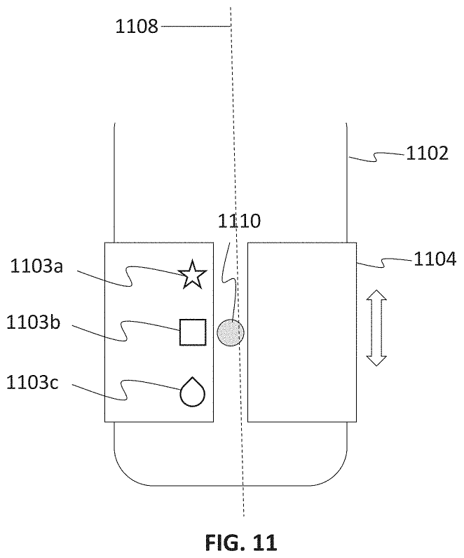

Other configurations of cover and container such as those described above may also include a plurality of labels and a label indicator that function similarly to that in covers 904 and 1004 to indicate container content type. For example, as shown in FIG. 11, a cover 1104 may include a “C”-shaped cross-section with a labeling region including an arcuate gap (and omit a bottom cover portion), and the container may include a label indicator 1110. The cover 1104 may be positionable such that the arcuate gap exposes the label indicator 1110. Furthermore, the cover may be slidable or otherwise manipulated along a longitudinal axis 1108 such that a selected label (e.g., 903a, 903b, or 903c) may be aligned with the label indicator 1110 on the container. In some variations, the cover may include other kinds of labeling regions (e.g., cutout, etc.) as described above, to expose the label indicator 1110.

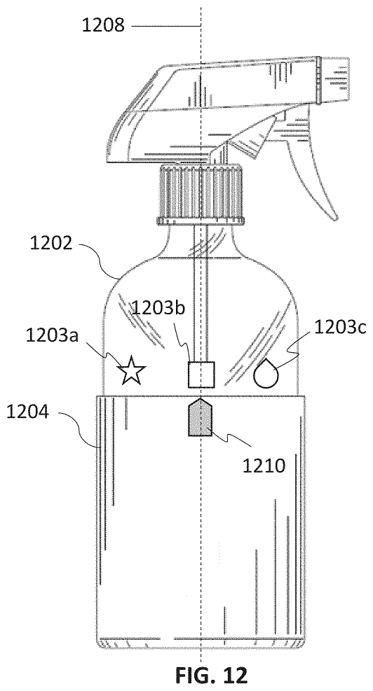

Furthermore, in some variations, the cover may include a label indicator (e.g., arrow similar to arrow 910 or 1010, or the like) or may itself function as a label indicator and may be manipulated to point to or otherwise indicate a desired label among a plurality of labels on the container. For example, FIG. 12 illustrates a cover 1204 having a label indicator 1210, where the cover may be placed on a container 1202 that includes a plurality of labels (e.g., 1203a-1203c, similar to that described above such as with respect to FIG. 2). The cover 1204 may be manipulated (e.g., rotated) around longitudinal axis 1208 such that its label indicator 1210 may be aligned with a selected label on the container 1202 to indicate container content type.

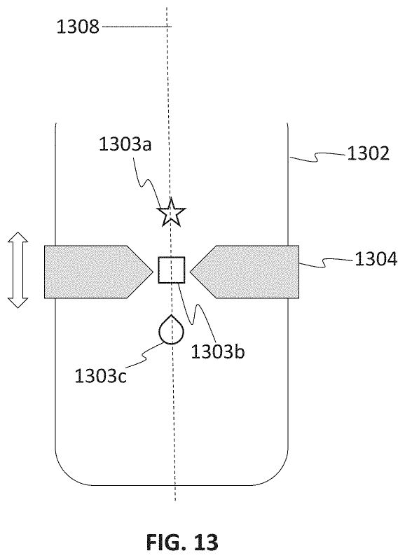

Other configurations of cover and container such as those described above may also include a plurality of labels and a label indicator that function similarly to that in cover 1204 to indicate container content type. For example, as shown in FIG. 13, a cover 1304 may include a “C”-shaped cross-section with a labeling region including an arcuate gap (and omit a bottom cover portion), and the container may include a plurality of labels (e.g., 1303a-1303c). The cover 1104 may function as (or include) a label indicator. The cover 1304 may be positionable such that the label indicator is aligned with a selected label on the container 1302 and the selected label is in the arcuate gap of the cover. Furthermore, the cover may be slidable or otherwise manipulated along a longitudinal axis 1308 such that the label indicator is aligned with a different selected label on the container. In some variations, the cover may include other kinds of labeling regions (e.g., cutout, etc.) as described above, to expose the label indicator 1110.

### Method of Using System

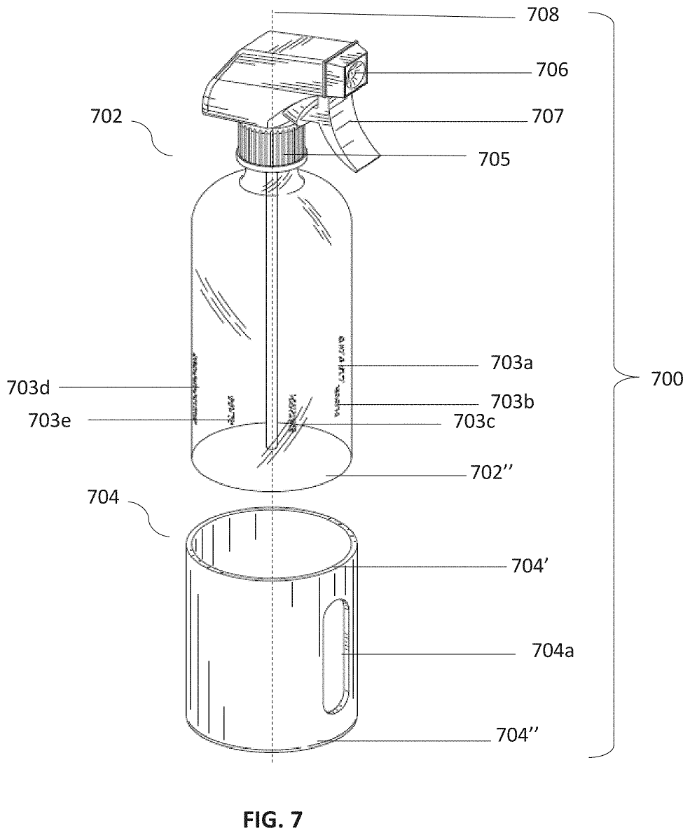

A method for using the system (e.g., system 100 in FIG. 1) includes placing a cover on a container to partially surround the container. FIG. 7 illustrates an exploded view of an exemplary variation of a system 700 for container content identification. As discussed above with respect to FIG. 1, the container 702 may include a plurality of labels 703a-703e, collectively referred to as labels 703. Each label 703 may represent a respective content type. The cover 704 may include a labeling region 704a, a top portion 704′, and a bottom portion 704″. The bottom portion 704″ may include one or more cutouts (not visible in FIG. 7), similar to that described above with respect to FIG. 6.

In some variations, placing the cover 704 on the container 702 may include inserting the container 702 through the top portion 704′ of the cover 704. The container 702 may be inserted such that a bottom portion 702″ of the container 702 may contact an inner surface of a bottom portion 704″ of the cover 704. Alternatively, the container 702 may be inserted such that the bottom portion 702″ of the container 702 extends out of the bottom portion 704″ of the cover 704 (e.g., the cover 704 may have two open ends and function like a sleeve). Furthermore, in some variations placing the cover 704 on the container 702 may include inserting the container 702 through the bottom portion 702″ of the container. In some variations, placing the cover 704 on the container 702 may partially surround the container 702. For example, placing the cover 704 may surround a bottom half of the container 702.

The method for using the system 700 may also include selectively positioning the labeling region 704a so as to expose a label 703. For example, after the cover 704 is placed on the container 702, the cover may be rotated around a longitudinal axis 708 so as to expose a label 703 on the container 702. The cover 704 may be rotated around the longitudinal axis 708 such that the labeling region 704a exposes one of the labels 703a-703e. In some variations, if the labels 703a-703e are at different heights or longitudinal positions on the container 702 and/or if the labels 703a-703e are at different orientations relative to the longitudinal axis 708, the cover 704 may be additionally or alternatively moved upward and/or downward along the longitudinal axis 708. The combination of rotation and/or slidable motion of the cover 704 around or along the longitudinal axis 708 may expose the labels 703 on the container 702.

The method for using the system 700 may further include manipulating (e.g., repositioning, reshaping, etc.) the labeling region 704a to expose another label on the container 702. For example, consider that the labeling region 704a is selectively positioned to expose label 703a. The label 703a may be indicative of a content type in the container 702. When the content type is switched out for a new content, the container may be re-purposed for the new content type. Consider that label 703b may be indicative of the new content type. The cover 704 may be rotated and/or moved (e.g., upward and/or downward) along the longitudinal axis 708 to expose the label 703b. In this manner, the cover 704 may be positioned and/or repositioned to selectively position the labeling region 704a to expose a label 703 on the container 702.

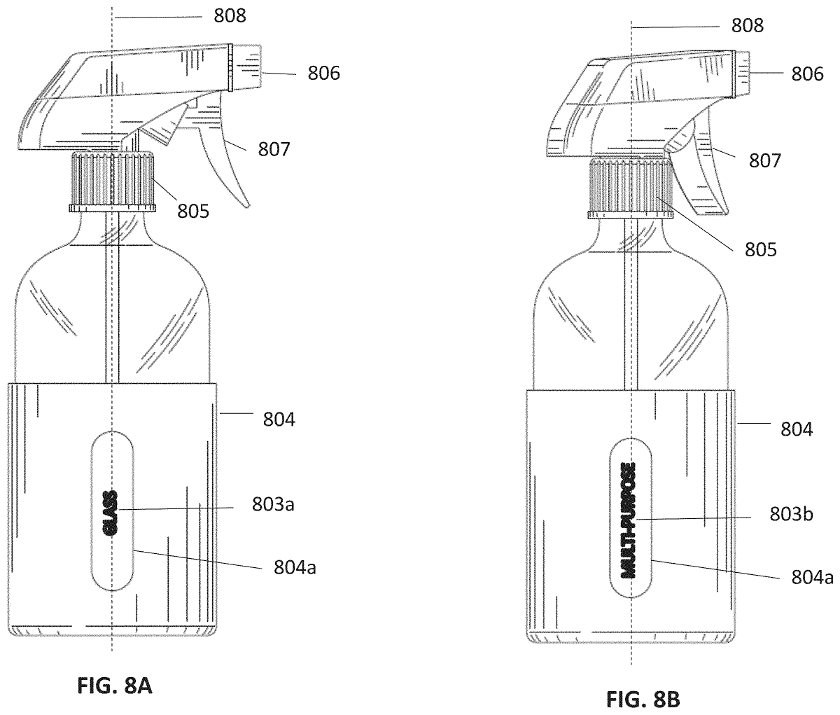

FIGS. 8A-8D illustrate an exemplary variation of a system that exposes different labels 803a-803d on the container 802. For the purposes of discussion of FIGS. 8A-8D, a “front view” of the cover 804 may be considered as a view of the cover with the labeling region 804a appearing in the front. FIGS. 8A-8D illustrate the front view of the cover 804 after positioning and/or repositioning the cover 804 on the container 802. The labels 803a-803d in FIGS. 8A-8D are indicative of a type of cleaning solution that may be stored in the container 802. However, it should be understood that in some variations, the labels may be indicative of any suitable kind of content (e.g., food, drink, etc.).

In FIG. 8A, the cover 804 may be positioned so as to expose label 803a. For example, the cover 804 may be rotated around the longitudinal axis 808 such that the labeling region 804a may be selectively positioned to expose the label 803a. In FIG. 8A, the front view of the cover 804 shows that the nozzle 806 and the trigger 807 may be oriented perpendicular to the longitudinal axis 808. Label 803a indicates that the cleaning solution in the container 802 may be a solution to clean “GLASS.”

As discussed above, the container 802 may be re-purposed to store other types of cleaning solutions. In FIG. 8B, the container 802 is re-purposed to store a “MULTI-PURPOSE” cleaning solution. The cover 804 may be re-positioned relative to the container so as to expose label 803b indicating the multi-purpose cleaning solution. For example, t cover 804 may be rotated clockwise relative to the container (when viewed from the top) around the longitudinal axis 808 such that the labeling region 804a may move clockwise in order to be selectively positioned to expose the label 803b.

In FIG. 8C, the container 802 is re-purposed to store a “TUB & TILE” cleaning solution. The cover 804 may be re-positioned relative to the container so as to expose label 803c indicating the tub and tile cleaning solution. For example, the cover 804 may be further rotated clockwise relative to the container (when viewed from the top) around the longitudinal axis 808 such that the labeling region 804a may move further in the clockwise direction in order to be selectively positioned to expose the label 803c.

In FIG. 8D, the container 802 is re-purposed to store a “SHOWER” cleaning solution. The cover 804 may be re-positioned relative to the container so as to expose label 803d indicating the shower cleaning solution. For example, cover 804 may be further rotated clockwise relative to the container (when viewed from the top) around the longitudinal axis 808 such that the labeling region 804a may be selectively positioned to expose the label 803d.

In some variations, the method for using the system may further include selecting the nozzle 806 and/or the trigger 807 such that a color of the nozzle 806 and/or the trigger 807 may match a color of the cover 804. For example, in some variations, the color of the cover 804 may be changed to indicate a change in content type. In FIG. 8A, the cover 804 may have a first color to indicate that the cleaning solution is a solution for cleaning glass. When the content type is switched to multi-purpose cleaning solution, the color of the cover 804 may be changed to a second color. The color may be changed by attaching a colored filament and/or a colored paper to the cover 804. Alternatively, the cover itself may be detached and changed for a different cover with a different color. The nozzle 806 and/or the trigger 807 may also be selectively changed to match the color of the cover 804.

In some variations, the method for using the system may further include detaching the cover 804 from the container. As discussed above, a bottom portion of the cover 804 may include a cutout. The cover 804 may be detached by pulling an inner surface of the bottom portion of the cover 804 through the cutout.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to explain the principles of the invention and its practical applications, they thereby enable others skilled in the art to utilize the invention and various embodiments with various modifications as are suited to the particular use contemplated. It is intended that the following claims and their equivalents define the scope of the invention.

1. An apparatus comprising:
a container comprising a plurality of labels; and
a cover at least partially surrounding the container, the cover including a labeling region selectively positionable to expose a label of the plurality of labels, wherein the exposed label is indicative of a container content type.

2. The apparatus of claim 1, wherein the cover comprises a sleeve.

3. The apparatus of claim 1, wherein the cover comprises silicone.

4. (canceled)

5. The apparatus of claim 1, wherein the labeling region is a negative space.

6. The apparatus of claim 5, wherein the negative space comprises a transparent material.

7-8. (canceled)

9. The apparatus of claim 1, wherein a segment of the cover surrounding a bottom portion of the container includes a cutout.

10. The apparatus of claim 1, wherein the cover is configured to be detachable from the container.

11. The apparatus of claim 1, wherein the cover surrounding the container is rotatable relative to the container such that the labeling region is selectively positioned to expose a second label of the plurality of labels.

12. The apparatus of claim 11, wherein the content is of a first content type and the second label is indicative of a second container content type.

13. The apparatus of claim 1, wherein the labeling region is rotatable around a longitudinal axis of the container.

14. The apparatus of claim 13, wherein the plurality of labels are oriented parallel to the longitudinal axis of the container.

15. The apparatus of claim 13, wherein the plurality of labels are oriented at an angle relative to the longitudinal axis of the container.

16. The apparatus of claim 1, wherein the labeling region is translatable along a longitudinal axis.

17. The apparatus of claim 16, wherein the plurality of labels are oriented perpendicular to the longitudinal axis.

18. The apparatus of claim 16, wherein the plurality of labels are oriented at an angle relative to the longitudinal axis.

19. The apparatus of claim 1, wherein one or more labels in the plurality of labels are indicative of a type of cleaner solution.

20. The apparatus of claim 1, wherein the plurality of labels are on a surface of the container.

21. The apparatus of claim 1, further comprising a dispenser coupled to the container.

22. The apparatus of claim 21, wherein a first color of the dispenser matches a second color of the cover.

23. A method comprising:
placing a cover on a container such that the cover at least partially surrounds the container, wherein the container comprises a plurality of labels; and
positioning the cover to selectively position a labeling region in the cover to expose a label of the plurality of labels,
wherein the label is indicative of a container content type.

24-41. (canceled)
